(19) United States
(12) Patent Application Publication
(10) Pub. No.: US 2008/0189386 A1
(43) Pub. Date: Aug. 7, 2008

(54) WEB-BASED METHODS AND SYSTEMS FOR MANUFACTURING AND SELLING CUSTOM-MADE, HIGH-END PRODUCTS

(75) Inventors: Ellen Sally Waldinger, Amherst, MA (US); Kathleen Rita Lugosch, Amherst, MA (US)

Correspondence Address: CHOATE, HALL & STEWART LLP, TWO INTERNATIONAL PLACE, BOSTON, MA, 02110, US

(73) Assignee: Delos & Laurel, LLC, Amherst, MA (US)

(21) Appl. No.: 11/671,791

(22) Filed: Feb. 6, 2007

(51) Int. Cl. G06F 15/16

(52) U.S. Cl. 709/217

(57) ABSTRACT

A web-based method for manufacturing and selling custom-made, high-end products includes the step of receiving, by a designer, information from a remote client relating to the remote client's environment and preferences, all the information received from the remote client. The designer selects an item satisfying a design need of the environment. A representation of the environment including the selected item is displayed to the remote client. The designer issues, to a manufacturer, a purchase order for the selected item.

### FIELD OF THE INVENTION

The present invention relates to methods and systems for providing design services. In particular, the present invention relates to web-based methods and systems for manufacturing and selling custom-made, high-end products.

### BACKGROUND OF THE INVENTION

Consumers may consult with professionally-trained designers or architects to create or enhance functional and aesthetically-attractive environments. For example, designers or architects may provide services including project management, selection of items for purchase, and formulation of plans that integrate a client's needs, based on certain principles and theories. Interior designers or architects may use their experience and training to provide their clients with insight and advice on creating and enhancing interior, residential environments. However, working with consultants typically requires the client to dedicate a significant amount of time to meet with the consultant, in-person, to complete a project. Clients typically have an initial consultation with the designer or architect, followed by a series of meetings and discussions as the project progresses. These consultations include meetings at a client's residence and meetings at the designer's or architect's offices. Meetings are required for the client and the consultant to understand and develop the client's goals and environment, to exchange information, select and purchase items, and to complete the project.

Manufacturers who produce residential furniture that is constructed with a major emphasis on the aesthetic and crafted features of the furniture and furnishings and that often necessitates customization (of finishes, ornamentation, fabric and trim choice and detailing), rely on designers or architects to select and customize this furniture and furnishings for the designers' or architects' clients. These manufacturers sell their furniture and furnishings to showrooms that are found in design centers. These showrooms, in turn, sell the furniture and furnishings to members of the design trade who then re-sell the products to their own clients. Some manufacturers also sell their furniture and furnishings to retail stores, in the belief that these stores will provide high-level assistance (inclusive of a knowledgeable sales force and sometimes also of in-house designers or architects), who will assist the stores' customers in a well-thought-through purchase of these highly crafted products.

Manufacturers of highly crafted and customizable furniture and furnishings are, therefore, typically dependent on distribution via physically-located showrooms. This dependence increases the cost of a sale (due to the many different kinds of costs associated with showroom real-estate), decreases the manufacturers' ability to reach a widely-disbursed client base, and minimizes the ability of clients to gain access to highly-crafted and customizable furniture and furnishings.

### SUMMARY OF THE INVENTION

Methods and systems for providing person-to-person, high-end design services increase the availability of high-end interior design and products, increase the demand for these highly-crafted quality products, and create a positive impact on the environment. Methods and systems for providing person-to-person, high-end design services may utilize technology, professional services, and multiple means of communication to improve the designed decoration of interiors by virtualizing multiple physical phenomena, producing design remotely, and improving the distribution of high-end products.

Methods and systems for enabling designers to collaborate remotely with their clients and to provide remote clients with person-to-person, high-end design services enable manufacturers of highly-crafted and customizable furniture and furnishings to continue to utilize designers to distribute their products to customers while freeing that distribution from dependence on physically-located showrooms. Such methods provide multiple benefits relative to reducing the cost of a sale (for example, by freeing the sale from the many different kinds of costs associated with showroom-real-estate), to the manufacturers' reaching a far larger and more widely-disbursed client base, and to that larger and more widely-disbursed client base gaining access to this highly-crafted and customizable furniture and furnishings.

In one aspect, a web-based method for manufacturing and selling custom-made, high-end products includes the step of receiving, by a designer, information from a remote client relating to the remote client's environment and preferences, all the information received from the remote client. The designer selects an item satisfying a design need of the environment. A representation of the environment including the selected item is displayed to the remote client. The designer issues, to a manufacturer, a purchase order for the selected item.

In one embodiment, the designer receives a characteristic of a physical surrounding of the remote client. In another embodiment, the designer receives the information without physical proximity to the remote client. In still another embodiment, the designer selects a piece of furniture having a brand name affiliated with a high-end furniture manufacturer. In yet another embodiment, the designer selects a piece of furniture that requires customization.

In one embodiment, the remote client purchases the selected item. In another embodiment, the manufacturer custom-makes the selected item for the remote client. In still another embodiment, the manufacturer ships the selected item to the remote client.

### BRIEF DESCRIPTION OF THE DRAWINGS

The foregoing and other objects, aspects, features, and advantages of the invention will become more apparent and better understood by referring to the following description taken in conjunction with the accompanying drawings, in which:

FIG. 1A is a block diagram depicting an embodiment of a network environment comprising client machines in communication with remote machines;

FIG. 1B is a block diagram depicting an embodiment of a computer useful in connection with the methods and systems described herein;

FIG. 2 is a flow diagram depicting one embodiment of the steps taken in a web-based method for providing person-to-person, high-end design services;

FIG. 3 is a block diagram depicting one embodiment of a system for providing person-to-person, high-end design services; and

FIG. 4 is a flow diagram depicting one embodiment of the steps taken in a web-based method for manufacturing and selling custom-made, high-end products.

### DETAILED DESCRIPTION OF THE INVENTION

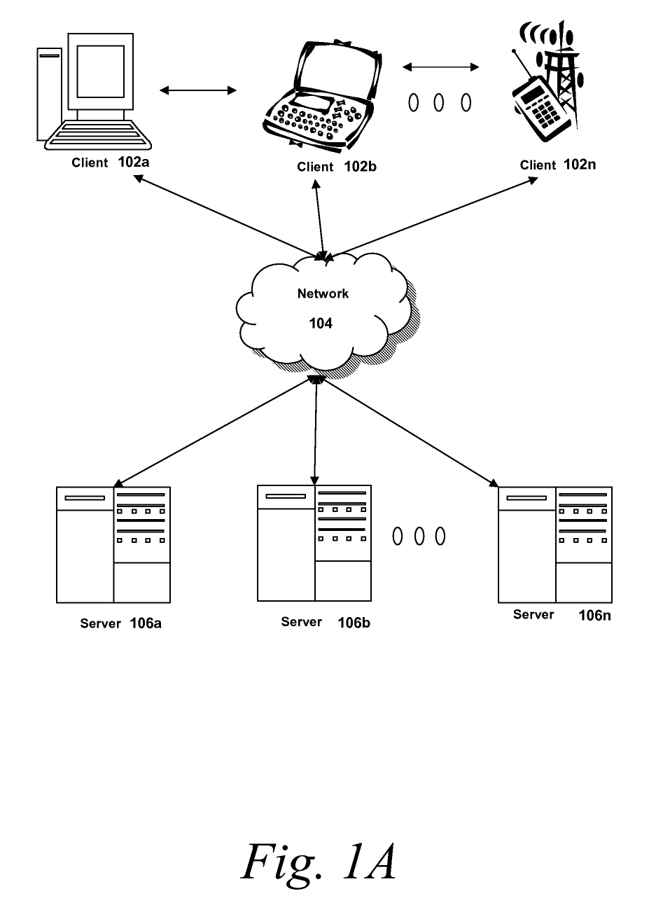

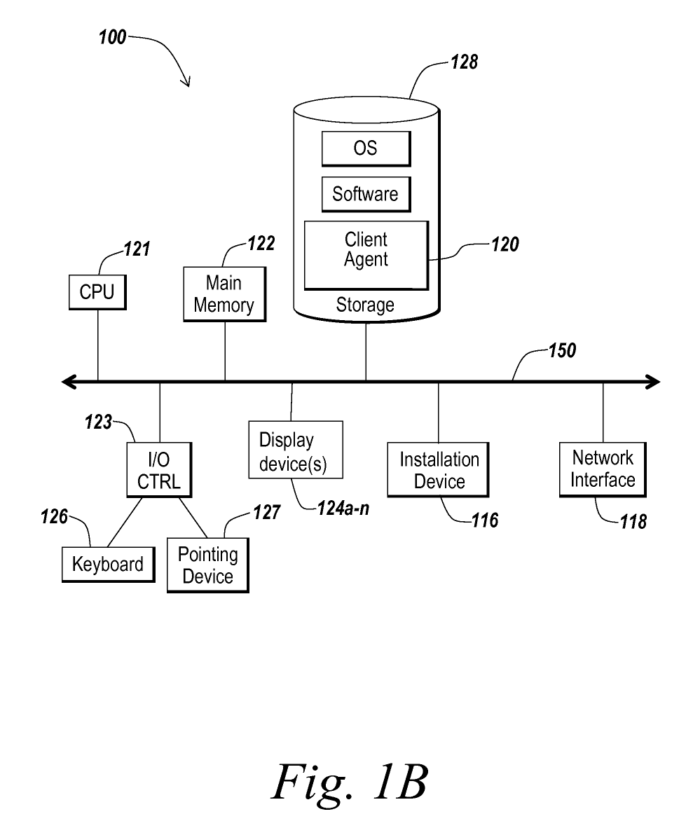

Referring now to FIG. 1A, an embodiment of a network environment is depicted. In brief overview, the network environment comprises one or more clients 102a-102n (also generally referred to as local machine(s) 102, or client(s) 102) in communication with one or more servers 106a-106n (also generally referred to as server(s) 106, or remote machine(s) 106) via one or more networks 104.

The network 104 can be a local-area network (LAN), such as a company Intranet, a metropolitan area network (MAN), or a wide area network (WAN), such as the Internet or the World Wide Web. In some embodiments, there are multiple networks 104 between the clients 102 and the servers 106. In one of these embodiments, a network 104′ may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 and network topology may be of any such network or network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

In some embodiments, the servers 106 may be geographically dispersed from each other or from the clients 102. The servers 106 and the clients 102 may be heterogeneous. One or more of the servers 106 or clients 102 can operate according to one type of operating system platform (e.g., WINDOWS NT, manufactured by Microsoft Corp. of Redmond, Wash.), while one or more of the other servers 106 or clients 102 can operate on according to another type of operating system platform (e.g., Unix or Linux). The clients 102 and the servers 106 may be interconnected using a wide-area network (WAN) connection or a metropolitan-area network (MAN) connection. Data transmission speeds between servers 106 and clients 102 can be increased if the servers 106 and the clients 102 are connected using a local-area network (LAN) connection or some form of direct connection.

A server 106 may be referred to as a file server, application server, web server, proxy server, or gateway server. In some embodiments, a server 106 may have the capacity to function as either an application server or as a master application server. In one embodiment, a server 106 may include an Active Directory. The clients 102 may also be referred to as client nodes, client machines, endpoint nodes, or endpoints. In some embodiments, a client 102 has the capacity to function as both a client node seeking access to resources provided by a server and as a server providing access to hosted resources for other clients 102a-102n.

In some embodiments, a client 102 communicates with a server 106. In one embodiment, the client 102 communicates directly with one of the servers 106. In another embodiment, the client 102 communicates with a server 106 through a network 104. Over the network 104, the client 102 can, for example, request access to resources hosted by the servers 106a-106n. In other embodiments, a client 102a communicates with a client 102b. In one of these embodiments, the client 102a communicates directly with one of the clients 102. In another of these embodiments, the client 102a communicates with the client 102b through a network 104.

In one embodiment, the server 106 provides functionality of a web server. In another embodiment, the server 106a receives requests from the client 102, forwards the requests to a second server 106b and responds to the request by the client 102 with a response to the request from the server 106b. In some embodiments, the web server 106 comprises an open-source web server, such as the APACHE servers maintained by the Apache Software Foundation of Delaware. In other embodiments, the web server executes proprietary software, such as the Internet Information Services (IIS) products provided by Microsoft Corporation of Redmond, Wash., the SUN JAVA web server products provided by Sun Microsystems, of Santa Clara, Calif., or the BEA WEBLOGIC products provided by BEA Systems, of Santa Clara, Calif. In still other embodiments, the web server 106 provides support for security features such as authentication, authorization, or secure hyper-text transfer protocol. In yet other embodiments, the web server 106 provides support for dynamic content technologies.

In some embodiments, the server 106 may be running one or more applications. In other embodiments, any of the applications may comprise any type of hosted service or products, such as GOTOMEETING provided by Citrix Online Division, Inc. of Santa Barbara, Calif., WEBEX provided by WebEx, Inc. of Santa Clara, Calif., or Microsoft Office LIVE MEETING provided by Microsoft Corporation of Redmond, Wash. In still other embodiments, the server 106 may function as a web or Internet server, or a desktop sharing server, or a collaboration server.

A client 102 may execute, operate or otherwise provide an application, which can be any type and/or form of software, program, or executable instructions such as any type and/or form of web browser, web-based client, client-server application, an ActiveX control, or a Java applet, or any other type and/or form of executable instructions capable of executing on client 102. The application can use any type of protocol and it can be, for example, an HTTP client, an FTP client, an Oscar client, or a Telnet client. In one embodiment, the application comprises any type of software related to voice over internet protocol (VoIP) communications, such as a soft IP telephone. In another embodiment, the application comprises any application related to real-time data communications, such as applications for streaming video and/or audio.

The client 102 and server 106 may be deployed as and/or executed on any type and form of computing device, such as a computer, network device or appliance capable of communicating on any type and form of network and performing the operations described herein. FIG. 1B depicts a block diagram of a computing device 100 useful for practicing an embodiment of the client 102 or a server 106. As shown in FIG. 1B, each computing device 100 includes a central processing unit 121, and a main memory unit 122. As shown in FIG. 1B, a computing device 100 may include a visual display device 124, a keyboard 126 and/or a pointing device 127, such as a mouse.

The central processing unit 121 is any logic circuitry that responds to and processes instructions fetched from the main memory unit 122. In many embodiments, the central processing unit is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

The computing device 100 may include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25), broadband connections (e.g., ISDN, Frame Relay, ATM), wireless connections, or some combination of any or all of the above. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

A wide variety of I/O devices 130a-130n may be present in the computing device 100. Input devices include keyboards, mice, trackpads, trackballs, microphones, and drawing tablets. Output devices include video displays, speakers, inkjet printers, laser printers, and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections to receive handheld USB storage devices such as the USB Flash Drive line of devices manufactured by Twintech Industry, Inc. of Los Alamitos, Calif.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIG. 1B typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include: WINDOWS 3.x, WINDOWS 95, WINDOWS 98, WINDOWS 2000, WINDOWS NT 3.51, WINDOWS NT 4.0, WINDOWS CE, and WINDOWS XP, all of which are manufactured by Microsoft Corporation of Redmond, Wash.; MAC OS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

In some embodiments, the computing device 100 may have different processors, operating systems, and input devices consistent with the device. For example, in one embodiment the computing device 100 is a Treo 180, 270, 600, 650, 680, 700p or 700w smart phone manufactured by Palm, Inc. In some of these embodiments, the Treo smart phone is operated under the control of the PalmOS operating system and includes a stylus input device as well as a five-way navigator device.

In other embodiments the computing device 100 is a mobile device, such as a JAVA-enabled cellular telephone or personal digital assistant (PDA), such as the i55sr, i58sr, i85s, i88s, i90c, i95cl, or the iM1100, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea.

In still other embodiments, the computing device 100 is a Blackberry handheld or smart phone, such as the devices manufactured by Research In Motion Limited, including the Blackberry 7100 series, 8700 series, 7700 series, 7200 series, the Blackberry 7520, or the Blackberry Pearl 8100. In yet other embodiments, the computing device 100 is a smart phone, Pocket PC, Pocket PC Phone, or other handheld mobile device supporting Microsoft Windows Mobile Software. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

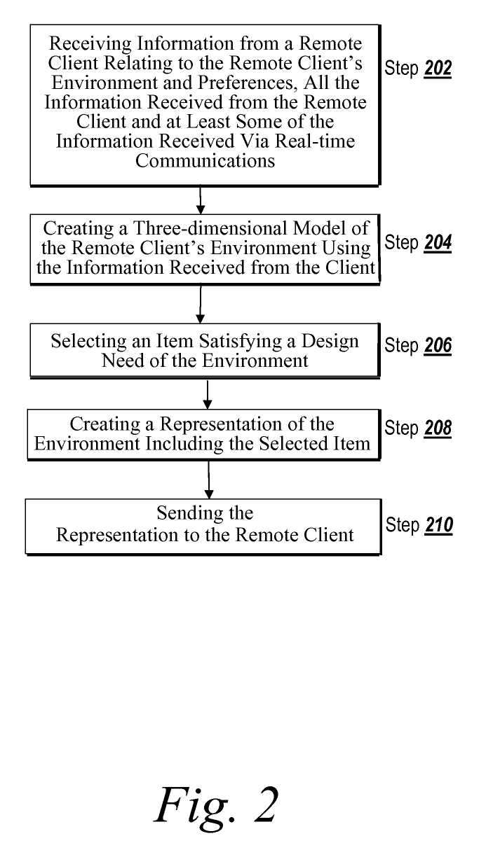

Referring now to FIG. 2, a flow diagram depicts one embodiment of the steps taken in a web-based method for providing person-to-person, high-end design services. In brief overview, information is received from a remote client relating to the remote client's environment and preferences, all the information received from the remote client and at least some of the information received via real-time communications (step 202). A three-dimensional model of the remote client's environment is created using the information received from the client (step 204). An item satisfying a design need of the environment is selected (step 206). A representation of the environment including the selected item is created (step 208). The representation is sent to the remote client (step 210). A web-based system for providing person-to-person, high-end design services includes a means for creating a three-dimensional model of the remote client's environment using the information received from the client and a means for selecting an item satisfying a design need of the environment. The system also includes a means for creating a representation of the environment including the selected item and a means for sending the representation to the remote client.

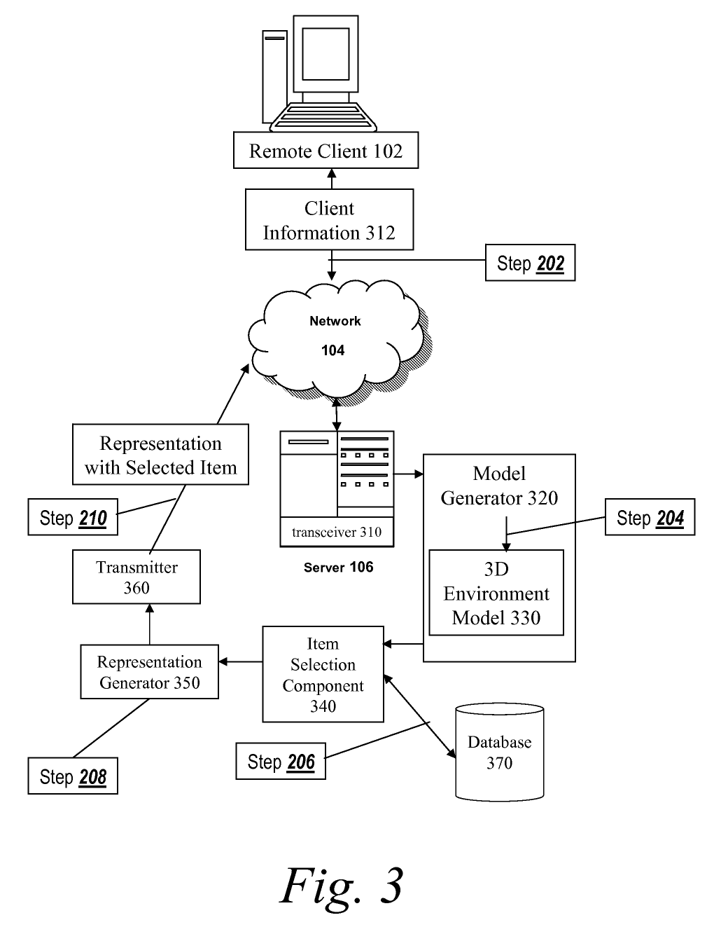

In more detail, and also in connection with FIG. 3, information is received from a remote client relating to the remote client's environment and preferences, all the information received from the remote client and at least some of the information received via real-time communications (step 202). In some embodiments, a designer or architect working with the remote client receives the information. In one of these embodiments, the designer is an interior designer. In another of these embodiments, the designer or architect consults with the remote client via a telephone conference. In still another of these embodiments, the remote client provides the information subsequent to an initial consultation establishing a relationship with the designer or architect.

In some embodiments, the remote client and a designer or architect work together on a design project. The design project may include, without limitation, furnishing all or part of the remote client's residence, identifying functional, aesthetically-attractive, and high-end furnishings and decorations to incorporate into the remote client's residence, and other projects for providing creative, aesthetically-attractive solutions to the remote client's interior design needs. In other embodiments, the information is received without the need for an in-person consultation between the client and a designer or an architect. In still other embodiments, the information is received over a network.

In some embodiments, a designer or architect hired by a remote client to oversee and complete a design project provides the remote client with web-based systems for communicating with the designer or architect and with which the designer or architect may provide the remote client with person-to-person, high end design services. In one of these embodiments, the designer or architect provides communications tools enabling the designer or architect and the remote client to exchange information relating to a design project. In another of these embodiments, the remote client uses a client machine, such as the client machine 102 described above in connection with FIG. 1A and FIG. 1B, to communicate with the designer or architect.

In still another of these embodiments, the designer or architect uses a server, such as the server 106 described above in connection with FIG. 1A and FIG. 1B to provide communications tools to and exchange information with the remote client. A web-based system for providing person-to-person, high-end design services includes a means for creating a three-dimensional model of the remote client's environment using the information received from the client and a means for selecting an item satisfying a design need of the environment. The system also includes a means for creating a representation of the environment including the selected item and a means for sending the representation to the remote client.

In one embodiment, a means for receiving the information from the remote client resides on a server 106. In another embodiment, as depicted in FIG. 3, a transceiver 310 on the server 106 receives the information.

In one embodiment, a location on a network, such as a web site provided by the server 106, is designed for the designer or architect and the remote client to exchange information and collaborate on a project, such as an interior design project. In another embodiment, the location displays a virtual showroom to the remote client. In still another embodiment, the virtual showroom includes a three-dimensional representation of the environment including a designer- or architect-selected item. In some embodiments, a location accessible by the remote client stores the received information. In one of these embodiments, the location is a web site accessible via a network 104. In another of these embodiments, the location is accessible to a designer or architect assisting the remote client. In still another of these embodiments, the location is a private web site.

In one of these embodiments, the location is personalized for the remote client, responsive to the received information. For example, if the remote client works with a designer or architect on an interior design project, the designer or architect may provide links to articles relating to interior design, photographs of furniture or other items the designer or architect chooses to share with the remote client to improve his or her understanding of the remote client's preferences and requirements, or other information related to the project. In another of these embodiments, for example where the location is a web site, the location provides the remote client and a designer or architect working with the remote client with a location for storing information related to the design of the remote client's environment and to the projects on which the remote client and the designer or architect collaborate. In still another of these embodiments, the location provides information to the remote client selected responsive to the received information. For example, the information may include, without limitation, links to resources related to the received information, photographs of design concepts related to the received information, articles and educational content related to the received information or to a request for additional information received from the remote client.

In still another of these embodiments, the location provides functionality for exchanging electronic communications. In one embodiment, the location provides functionality for uploading, by the remote client or a designer or architect, information, such as a web log entry, an electronic bulletin board entry, or an addition to a photograph gallery, for viewing on the location. In another embodiment, the remote client may use a tool provided at the location to send or receive electronic mail. In still another embodiment, a designer or architect may use a tool provided at the location to send to or receive electronic mail from the remote client. The location may provide functionality for exchanging electronic real-time communications. In yet another embodiment, the remote client and a designer or architect may communicate using a real-time collaboration tool provided at the location. For example, the remote client and the designer or architect may communicate using an instant messaging service, a screen-sharing service, or other tool for real-time collaboration.

In one embodiment, the received information may include a characteristic of a physical surrounding of the remote client. In another embodiment, the received information may include a characteristic of a residential environment of the remote client. In still another embodiment, the received information may include a measurement, such as a measurement of a room or other space in the residential environment of the remote client. For example, the remote client may provide detailed descriptions of his or her residence, or of a portion of his or her residence. The remote client may describe a style of residence, a characteristic of the property, a characteristic of the neighborhood, a physical characteristic of the residence, or other information related to the residential environment.

A designer or architect collaborating with a client on a project such as an interior design project may need to see the house, or the section of the house to which the interior design project relates. Receiving the information remotely—via telephone, over a network, through the postal service—enables the designer or architect to work with the client without requiring an in-person meeting, providing the designer or architect and the client with greater flexibility. In one embodiment, the designer or architect receives the information relating to the client's environment or preferences without meeting with the client in person.

In one embodiment, the information is received telephonically. In another embodiment, the remote client provides a photograph of the information. In some embodiments, the information is received electronically. In one of these embodiments, the remote client provides the information via an electronic mail message, including text messages or multimedia messages. In another of these embodiments, the remote client provides the information via an internet chat service. In still another of these embodiments, the remote client provides the information via an instant messaging service. In yet another of these embodiments, the remote client provides the information via a web-based system. In a further of these embodiments, the remote client provides the information via a web-based collaboration tool.

In some embodiments, information is exchanged with the remote client. For example, a designer or architect collaborating with the remote client may wish to exchange information with the remote client, and not merely receive information. In one of these embodiments, information is provided to the remote client relating to the remote client's environment and preferences. In another of these embodiments, information is provided to the remote client via a web-based system. In still another of these embodiments, information is provided to the client telephonically. In yet another of these embodiments, information is provided to the remote client via an electronic mail message.

In one environment, information is provided to the remote client via an internet chat service. In another of these embodiments, information is provided to the remote client via an instant messaging service. In still another of these embodiments, information is provided to the remote client via a web-based system. In yet another of these embodiments, information is provided to the remote client via a web-based collaboration tool.

A three-dimensional model of the remote client's environment is created using the information received from the client (step 204). In one embodiment, depicted in FIG. 3, a means for creating a three-dimensional model 330 resides on the server 106. In another embodiment, the means for creating the three-dimensional model 330 resides on a different server 106.

In one embodiment, the means for creating the three-dimensional model 330 comprises a model generator 320. In some embodiments, the model generator 320 is a computer program, such as a computer-aided design software application program. In one of these embodiments, the computer program generates the three-dimensional model of the remote client's environment. In other embodiments, a human, such as the designer or architect collaborating with the remote client 102, generates the three-dimensional model 330 of the remote client's environment. In one of these embodiments, a designer or architect uses a computer program to generate the three-dimensional model.

In one embodiment, the three-dimensional model represents the remote client's existing environment. In another embodiment, the three-dimensional model is a floor plan of the remote client's environment. In still another embodiment, the three-dimensional model is a computer-generated image, rendered via a computer program.

An item satisfying a design need of the environment is selected (step 206). In one embodiment, a designer or architect selects the item satisfying the design need of the environment. In another embodiment, a computer program selects the item satisfying the design need of the environment. In still another embodiment, a designer or architect uses a computer program to identify an item satisfying the design need of the environment. In some embodiments, an item satisfying a design need furthers the design goals of the client and the designer or architect. In other embodiments, an item satisfying a design need fits the aesthetic and programmatic requirements of the client and of the project. In still other embodiments, a designer or architect consults a three-dimensional model of a plurality of items to determine whether one of the plurality of items satisfies the design need.

In some embodiments, a piece of furniture satisfying the design need is selected. In one of these embodiments, furniture includes, but is not limited to, sofas, sectionals, chairs, chaises, desks, tables, seats, bookcases, cabinets, foot stools, futons, occasional tables, recliners, loveseats. In another of these embodiments, furniture includes, but is not limited to, beds, sleepers, dressers, mirrors, night stands, vanities, and armoires. In still another of these embodiments, furniture includes, but is not limited to, buffets, sideboards, china cabinets, storage units, and benches.

In some embodiments, a furnishing satisfying the design need is selected. In one of these embodiments, furnishings include items used to decorate interior spaces, including, but not limited to, tableware, linens, decorative arts or objects, lighting, carpets, rugs, clocks, and mirrors. In other embodiments, an accessory satisfying the design need is selected. In still other embodiments, a painting satisfying the design need is selected. In yet other embodiments, a piece of fine art, including, but not limited to, paintings, photography, drawings and other works of art, satisfying the design need is selected.

In other embodiments, a fixture satisfying the design need is selected. In one of these embodiments, plumbing fixtures including, but not limited to, sinks, tubs, or showers are selected. In another of these embodiments, the material of the fixture satisfies the design need. For example, in a design project including the design or enhancement of a kitchen or bathroom, a plumbing fixture made of granite, stainless steel, enamel, porcelain, glass, soapstone, or terrazzo material may satisfy a particular design need. In still other embodiments, an appliance satisfying the design need is selected. In one of these embodiments, appliances include stoves and cooking appliances, refrigerators, freezers, clothing appliances such as washers and dryers, and other major household appliances.

In still other embodiments, an affixed finish satisfying the design need is selected. In one of these embodiments, flooring, including but not limited to tile, carpet, parquet, cork, is selected. In another of these embodiments, wall-and-ceiling-finishes, such as paint, wallpaper, trim, are selected. In still another of these embodiments, built-ins, such as closet cabinetry and shelves, or kitchen cabinetry or shelves, or benches, or bed-platforms, are selected.

In some embodiments, a textile satisfying the design need is selected. In one of these embodiments, textiles include fabrics, cloths, or leathers, or trim. In another of these embodiments, a textile satisfying a preference for a type of upholstery is selected.

In other embodiments, a type of drapery satisfying the design need is selected. In one of these embodiments, draperies include curtains, drapes, cloth or textiles. In another of these embodiments, window treatments, window blinds, or window shades are selected. In still other embodiments, a piece of clothing satisfying the design need is selected.

In some embodiments, an item satisfying the design need is selected, responsive to the information and to the three-dimensional model. In one of these embodiments, a designer or architect may select a particular item responsive to a preference expressed by a client for a type of upholstery, a size of a furnishing, or other preference. In another of these embodiments, the designer or architect may select a particular item responsive to an available size for the item in the room or other interior space into which the client will place the item. In still another of these embodiments, the designer or architect may select a particular item responsive to a budget restriction imposed by the remote client.

A means for selecting an item satisfying a design need of the environment, the item selection component 340 in FIG. 3, may be a software component, such as a computer program, selecting an item responsive to the received information. In other embodiments, a human, such as a designer or architect collaborating with the remote client 102 selects the item. In one of these embodiments, the designer or architect uses a computer program to select the item.

In some embodiments, a designer or architect uses a computer program to select an item, the computer program accessing a database to recommend to the designer or architect an item for selection. In one of these embodiments, the computer program receives, from the designer or architect, information about the remote client's environment or preferences. For example, the designer or architect may indicate to the computer program a style owned or preferred by the remote client. The designer or architect may indicate, for example, and without limitation, a style of furnishing or architecture, preferred by the client. The style preference may reflect the client's existing environment or the client's desired environment.

In another of these embodiments, the computer program provides the designer or architect with an enumeration of items satisfying a design need of the environment, responsive to requesting the enumeration of items from a database. For example, the designer or architect may request a list of furniture pieces satisfying a design need of the remote client's residence. The computer program receiving information about the residence may query the database—such as the database 370 depicted in FIG. 3—to identify the list of furniture. In still another of these embodiments, the enumeration of items may include three-dimensional images, such as computer-rendered or hand-drawn images, of the enumerated items. In yet another of these embodiments, the designer or architect selects the item satisfying the design need from the enumeration of items identified by the computer program.

In some embodiments, the database 370 stores data in an ODBC-compliant database. For example, the database 370 may be provided as an ORACLE database, manufactured by Oracle Corporation of Redwood Shores, Calif. In other embodiments, the database 370 can be a Microsoft ACCESS database or a Microsoft SQL server database, manufactured by Microsoft Corporation of Redmond, Wash.

A representation of the environment including the selected item is created (step 208). A representation generator 350 includes a means for creating a representation of the environment including the selected item. In some embodiments, the representation of the environment is created by a designer or architect. In one of these embodiments, the representation of the environment including the selected item comprises a hand-drawn sketch of the environment with the selected item. In another of these embodiments, the designer or architect uses a computer program, such as a computer-aided design software application program to create the representation. In still another embodiment, a computer program creates the representation of the environment, including a representation of the selected item. In yet another of these embodiments, the computer program inserts a three-dimensional rendering of the selected item into the representation.

In one embodiment, the representation of the environment is created by enhancing the three-dimensional model. For example, a designer or architect may revise a blue-print or floor plan to provide a three-dimensional representation of the environment. The designer or architect may add graphical elements to improve an aesthetic appeal of the representation. In another embodiment, the representation may include a design or blueprint for the construction of a new environment including the selected items and satisfying the design needs of the remote client.

In one embodiment, the representation of the environment includes a three-dimensional model of the selected item, allowing designers or architects and their clients to assess all the volumetric perspectives that are necessary in choosing an item satisfying the design need of the environment. In another embodiment, the three-dimensional representation of the environment in combination with the three-dimensional model of the selected item provides the designer or architect and the client with a virtual view of the environment with the object.

In one embodiment, a designer or architect adds a three-dimensional rendering of the selected item to the three-dimensional rendering of the client's environment. In another embodiment, the designer or architect and the remote client review the representation of the environment including the selected item via a web-based collaboration tool. In still another embodiment, the designer or architect and the client view this together, in a web conference in which they view the same computer screen.

The representation is sent to the remote client (step 210). In one embodiment, a transmitter 360 provides a means for sending the representation to the remote client 102. In another embodiment, the transmitter 360 resides on a server 106. In still another embodiment, the representation generator 350 includes a transmitter 360.

In one embodiment, the generated representation is sent to the client via postal service. In another embodiment, a sample of a characteristic of the selected item is sent to the remote item with the generated representation. In still another embodiment, a sample of a finish of the selected item is sent to the remote client with the generated representation. In yet another embodiment, a printed color sample associated with the selected item is sent to the remote client with the generated representation. In one embodiment, a fabric swatch is sent to the remote client with the generated representation. In another embodiment, a paint sample is sent to the remote client with the generated representation.

In some embodiments, the designer or architect sends a plurality of printed color samples to the client. In one of these embodiments, the client identifies one of the plurality of printed color samples matching the color-reality of the client's environment, i.e., the colors of existing furniture, furnishings, walls, etc. In another of these embodiments, the client identifies for the designer or architect one of the plurality of printed color samples matching an object in the client's environment. In still another of these embodiments, the designer or architect and the client use the identified printed color sample in selecting a color for the selected item identified by the designer or architect.

In one embodiment, a designer or architect working with the remote client sends the representation to the remote client. In another embodiment, the designer or architect sends the remote client related materials, such as printed color samples or fabric swatches, to assist the remote client in determining whether to include the selected item in the remote client's environment. For example, the designer or architect may send the remote client a sample finish suggested for a piece of furniture, with a fabric swatch suggested for the upholstery. In still another embodiment, the designer or architect may ask a manufacturer to send the remote client the related materials, samples, or swatches.

In one embodiment, the remote client purchases the selected item. In another embodiment, a goal of the design project is to identify an item satisfying a design need of the remote client which the remote client may then purchase. In still another embodiment, the designer or architect is able to provide the remote client with access to objects to which they have no physical proximity. For example, to accomplish this effect, the designer or architect may provide, without limitation, three-dimensional computer-rendered images of the item, photographs of the item or of attributes of the item to the client, and hand-drawn sketches of the item.

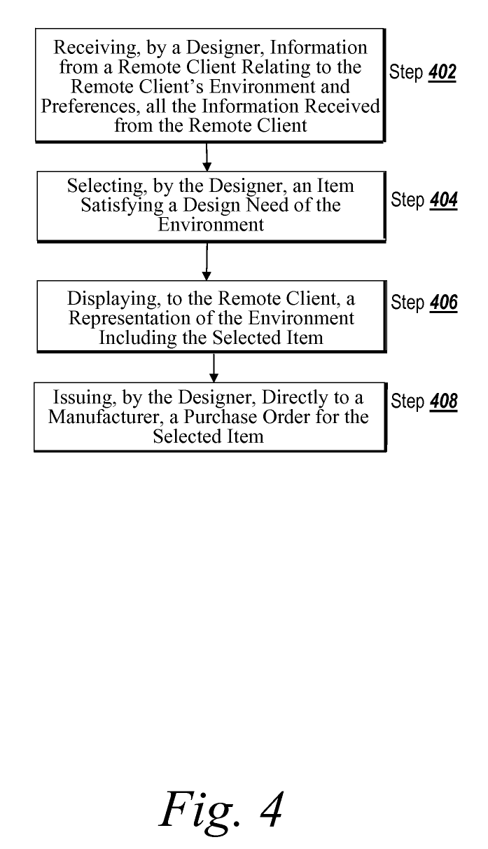

Referring now to FIG. 4, a flow diagram depicts one embodiment of the steps taken in a web-based method for manufacturing and selling custom-made, high-end products. In brief overview, a designer or architect receives information from a remote client relating to the remote client's environment and preferences, all the information received from the remote client (step 402). The designer or architect selects an item satisfying a design need of the environment (step 404). A representation of the environment including the selected item is displayed to the remote client (step 406). The designer or architect issues, to a manufacturer, a purchase order for the selected item (step 408).

In one embodiment, the designer or architect works with high-end manufacturers to provide the remote client with access to objects to which they have no physical proximity. In another embodiment, the designer or architect selects items that satisfy the design needs of the client and that are available from a high-end manufacturer with whom the designer or architect works. In still another embodiment, the designer or architect works with a high-end manufacture to provide customized furniture to the remote client for purchase.

Referring now to FIG. 4, and in greater detail, a designer or architect receives information from a remote client relating to the remote client's environment and preferences, all the information received from the remote client (step 402). In one embodiment, the designer or architect receives a characteristic of a physical surrounding of the remote client. In another embodiment, the designer or architect receives the information without physical proximity to the remote client. In still another embodiment, the designer or architect receives the information as described above in connection with FIG. 2 (step 202).

The designer or architect selects an item satisfying a design need of the environment (step 404). In one embodiment, the designer or architect selects an item that satisfies the design needs of the client and that are available from high-end manufacturers with whom the designer or architect works. In another embodiment, the designer or architect works with a high-end manufacturer to provide customized furniture to the remote client for purchase. In still another embodiment, the designer or architect selects a piece of furniture having a brand name affiliated with a high-end furniture manufacturer. In yet another embodiment, the designer or architect selects a customized piece of furniture. In some embodiments, the designer or architect selects the item as described above in connection with FIG. 2 (step 206).

A representation of the environment including the selected item is displayed to the remote client (step 406). In one embodiment, the representation of the environment is displayed to the remote client via a web site. In another embodiment, the representation of the environment is displayed to the remote client via a virtual showroom. In still another embodiment, the representation of the environment is created as described above in connection with FIG. 2 (step 208). In yet another embodiment, the representation is sent to the remote client as described above in connection with FIG. 2 (step 210).

In some embodiments, the manufacturer sends a sample of a characteristic of the selected item to the remote client. In one of these embodiments, the manufacturer sends a sample of a finish of the selected item to the remote client. In another of these embodiments, the manufacturer sends a printed color sample associated with the selected item to the remote client. In still another of these embodiments, the manufacturer sends a fabric swatch to the remote client. In other embodiments, the designer or architect sends a sample of a characteristic of the selected item to the remote client as described above in connection with FIG. 2.

The designer or architect issues, to a manufacturer, a purchase order for the selected item (step 408). In one embodiment, the remote client purchases the selected item. In another embodiment, the remote client purchases the selected item from the designer or architect. In still another embodiment, the remote client purchases the selected item from the manufacturer.

In one embodiment, the designer or architect issues the purchase order directly to the manufacturer. In another embodiment, the designer or architect issues the purchase order to a manufacturer-owned showroom. In still another embodiment, the designer or architect issues the purchase order to a third-party owner of a showroom, which transmits the purchase order to the manufacturer of the selected item.

In one embodiment, the manufacturer custom-makes the selected item for the remote client. In another embodiment, the manufacturer ships the selected item to the remote client. In still another embodiment, the manufacturer ships the selected item to the designer or architect.

The following illustrative examples show how the methods and systems described above can be used for providing person-to-person, high-end design services. These examples are meant to illustrate and not to limit the invention.

### EXAMPLE 1

In one embodiment, an interior designer or architect and a remote client have an initial consultation. During the initial consultation, the remote client and the interior designer or architect may identify an interior design project and discuss the goals, objectives, and requirements of the design project. In another embodiment, after the initial consultation, the remote client provides the interior designer or architect with information relating to the remote client's environment and preferences. The remote client's environment may be the remote client's residence. All of the information is received from the remote client, that is, the interior designer or architect receives the information without requiring physical proximity to the remote client.

At least some of the information is received via real-time communications. In some embodiments, the remote client provides the information to the interior designer or architect via a telephone conversation. In other embodiments, the remote client provides the information to the interior designer or architect over a network. In still other embodiments, the remote client mails the information to the interior designer or architect, for example, by mailing photographs of the environment to the interior designer or architect. In yet other embodiments, the interior designer or architect provides information to the remote client as well.

In one embodiment, the interior designer or architect uses the information received from the client to create a three-dimensional model of the remote client's environment. In another embodiment, the interior designer or architect generates a three-dimensional floor plan, blue-print, or other sketch of the remote client's existing environment. In some embodiments, the interior designer or architect uses a computer-aided design software program to create the three-dimensional model.

The interior designer or architect selects an item satisfying a design need of the environment. For example, the interior designer or architect may identify a piece of furniture to add to the environment, or to replace an existing item in the environment. In another example, the interior designer or architect may identify a furnishing, textile or drapery, or piece of fine art to add to the environment, or to replace an existing item in the environment.

The interior designer or architect creates a representation of the environment including the selected item. In some embodiments, the interior designer or architect sketches a representation of the environment, based on the three-dimensional model the interior designer or architect created. In one of these embodiments, the interior designer or architect sketches a representation that includes a drawing of the selected item. In another of these embodiments, the interior designer or architect sketches an aesthetically-appealing version of the three-dimensional model and includes a drawing of the selected item in the sketch.

In other embodiments, the interior designer or architect uses a computer program, such as a computer-aided design software program, to create the representation of the environment. In one of these embodiments, the interior designer or architect uses the computer program to create a representation including a representation of the selected item. In another of these embodiments, the interior designer or architect uses the computer program to insert a three-dimensional rendering of the selected item. In still another of these embodiments, the interior designer or architect uses the computer program to insert a three-dimensional computer-generated image of the selected item.

The interior designer or architect sends the representation to the remote client. In some embodiments, the interior designer or architect also sends the remote client additional information to assist the remote client in determining whether to purchase one or more designer- or architect-selected items. In one of these embodiments, the interior designer or architect also sends photographs of the item. In another of these embodiments, the interior designer or architect sends samples, such as fabric swatches, samples of finishes, multiple sketches or computer-generated renderings of the item or items, or other materials providing the remote client with additional information about the selected item or items. In one embodiment, the remote client purchases one or more of the selected items.

### EXAMPLE 2

In one embodiment, a designer or architect and a remote client have an initial consultation over the telephone to establish their relationship and to identify and discuss a design project, including a discussion of the goals and requirements of the design project. In another embodiment, the remote client then transmits to the designer or architect information to assist the designer or architect with the design project.

In one embodiment, the remote client and the designer or architect use a real-time collaboration tool to exchange information. For example, the remote client and the designer or architect may exchange instant messages in which they discuss the remote client's preferences. In another embodiment, the remote client and the designer or architect use a web-based collaboration tool to exchange information. For example, the remote client and the designer or architect may use screen-sharing technology to share photographs or digital media representing the remote client's environment and preferences, and use the communication features of the collaboration tool to discuss the information. In another example, the remote client and the designer or architect may use products such as GOTOMEETING, WEBEX, or LIVEMEETING, as described above in connection with FIG. 1A.

In some embodiments, the designer or architect provides the remote client with a private web site on which the designer or architect and the remote client may store and view information associated with the remote client's environment and preferences. In one of these embodiments, the designer or architect and the remote client may use the web site to store and view photographs, articles, advertisements, or links to external sites containing information relevant to the design project. In another of these embodiments, the web site may provide communications tools, such as electronic mail services, instant message services, or web logging services, with which the remote client and the designer or architect may communicate. In other embodiments, the use of these communications tools improves the ability of the remote client and the designer or architect to complete a design project without requiring in-person meetings or consultations. In still other embodiments, the use of the methods described above provides a level of understanding of the client's environment that maintains, and indeed enhances, the design professionalism that many manufacturers believe should be the context of a sale.

The systems and methods described above may be provided as one or more computer-readable programs embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, LISP, PERL, C, C++, PROLOG, or any byte code language such as JAVA. The software programs may be stored on or in one or more articles of manufacture as object code.

Having described certain embodiments of web-based methods and systems for manufacturing and selling custom-made, high-end products, it will now become apparent to one of skill in the art that other embodiments incorporating the concepts of the invention may be used. Therefore, the invention should not be limited to certain embodiments, but rather should be limited only by the spirit and scope of the following claims.

What is claimed is:

1. A web-based method for manufacturing and selling custom-made, high-end products, the method comprising the steps of:
(a) receiving, by a designer, information from a remote client relating to the remote client's environment and preferences, all the information received from the remote client;
(b) selecting, by the designer, an item satisfying a design need of the environment;
(c) displaying, to the remote client, a representation of the environment including the selected item; and
(d) issuing, by the designer, to a manufacturer, a purchase order for the selected item.

2. The method of claim 1, wherein step (a) further comprises receiving a characteristic of a physical surrounding of the remote client.

3. The method of claim 1, wherein step (a) further comprises receiving the information without physical proximity to the remote client.

4. The method of claim 1, wherein step (b) further comprises selecting a piece of furniture having a brand name affiliated with a high-end furniture manufacturer.

5. The method of claim 1, wherein step (b) further comprises selecting a customized piece of furniture.

6. The method of claim 1, wherein step (c) further comprises displaying, to the remote client, a representation of the environment including the selected item via a web site.

7. The method of claim 1, wherein step (c) further comprises displaying, to the remote client, a representation of the environment including the selected item via a virtual showroom.

8. The method of claim 1 further comprising the step of sending, by the manufacturer, a sample of a characteristic of the selected item to the remote client.

9. The method of claim 1 further comprising the step of sending a sample of a finish of the selected item to the remote client.

10. The method of claim 1 further comprising the step of sending a paint sample associated with the selected item to the remote client.

11. The method of claim 1 further comprising the step of sending a fabric swatch to the remote client.

12. The method of claim 1 further comprising the step of purchasing, by the remote client, the selected item.

13. The method of claim 1 further comprising the step of custom-making, by the manufacturer, the selected item for the remote client.

14. The method of claim 1 further comprising the step of shipping, by the manufacturer, to the remote client, the selected item.

15. The method of claim 1 further comprising the step of shipping, by the manufacturer, to the designer, the selected item.

16. A web-based system for manufacturing and selling custom-made, high-end products, comprising:
a means for receiving, by a designer, information from a remote client relating to the remote client's environment and preferences, all the information received from the remote client;
a means for selecting, by the designer, an item satisfying a design need of the environment;
a means for displaying, to the remote client, a representation of the environment including the selected item; and
a means for issuing, by the designer, to a manufacturer, a purchase order for the selected item.

17. The system of claim 16, wherein the means for receiving further comprises a means for receiving a characteristic of a physical surrounding of the remote client.

18. The system of claim 16, wherein the means for receiving further comprises a means for receiving the information without physical proximity to the remote client.

19. The system of claim 16, wherein the means for selecting further comprises a means for selecting a piece of furniture having a brand name affiliated with a high-end furniture manufacturer.

20. The system of claim 16, wherein the means for selecting further comprises a means for selecting a customized piece of furniture.

21. The system of claim 16, wherein the means for displaying further comprises a means for displaying, to the remote client, a representation of the environment including the selected item via a web site.

22. The system of claim 16, wherein the means for displaying further comprises a means for displaying, to the remote client, a representation of the environment including the selected item via a virtual showroom.

23. The system of claim 16 further comprising a means for sending, by the manufacturer, a sample of a characteristic of the selected item to the remote client.

24. The system of claim 16 further comprising a means for sending a sample of a finish of the selected item to the remote client.

25. The system of claim 16 further comprising a means for sending a paint sample associated with the selected item to the remote client.

26. The system of claim 16 further comprising a means for sending a printed color sample associated with the selected item to the remote client.

27. The system of claim 16 further comprising a means for sending a fabric swatch to the remote client.

28. The system of claim 16 further comprising a means for purchasing, by the remote client, the selected item.

29. The system of claim 16 further comprising a means for custom-making, by the manufacturer, the selected item for the remote client.

30. The system of claim 16 further comprising a means for shipping, by the manufacturer, to the remote client, the selected item.

31. The system of claim 16 further comprising a means for shipping, by the manufacturer, to the designer, the selected item.
